(19) United States
(12) Patent Application Publication
(10) Pub. No.: US 2007/0280313 A1
(43) Pub. Date: Dec. 6, 2007

(54) Method and Apparatus for Driving a Light Emitting Device

(76) Inventors: Chih-Cheng Hsieh, Hsin-Chu Hsien (TW); Sheng-Yeh Lai, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/422,332

(22) Filed: Jun. 6, 2006

(51) Int. Cl. H01S 3/13; H01S 3/00

(52) U.S. Cl. 372/38.02; 372/38.07; 372/29.015

(57) ABSTRACT

A method for driving a light emitting device includes providing a first current source coupled to an input terminal of the light emitting device, and providing a second current source coupled to an output terminal of the light emitting device.

### BACKGROUND OF THE INVENTION

1. Field of the Invention

The present invention provides a method and apparatus for driving a light emitting device, and more particularly, a method and apparatus for preventing the light emitting device from flashing or being damaged due to a circuit short.

2. Description of the Prior Art

Semiconductor light emitting devices, such as light emitting diodes (LEDs) and laser diodes (LDs), have been used widely in light bulbs, optical mouses, backlight sources of LCD monitors, etc. Products containing the semiconductor light emitting devices must conform to eye safety requirements, ex. IEC 60825-1, which must be observed not only during normal operation but when single faults occur.

If a single fault occurs, such as a circuit short occurs between an LED and ground or a voltage source, the LED will be driven by current over a predetermined amount, causing the LED to flash or become damaged. U.S. Pat. No. 6,704,183 discloses a fault detection in a LED bias circuit, which protects an LED from receiving too much current by adding bias current circuits, each containing a current sensing resistor and a current magnifying circuit, between an output terminal of the LED and ground. However, the fault detection disclosed in U.S. Pat. No. 6,704,183 can only detect circuit shorts between the output terminal and the ground. Therefore, when an input terminal of the LED is shorted with a driving source, such as a voltage generator, the fault detection cannot work, and thus the LED is driven by too much current with the result that the LED becomes too bright or damaged.

### SUMMARY OF THE INVENTION

It is therefore a primary objective of the claimed invention to provide a method and apparatus for driving a light emitting device.

According to the claimed invention, a method for driving a light emitting device comprises providing a first current source coupled to an input terminal of the light emitting device, providing a second current source coupled to an output terminal of the light emitting device, and controlling the first current source and the second current source according to voltages of the input terminal and the output terminal.

According to the claimed invention, an apparatus for driving a light emitting device comprises a first current source coupled to an input terminal of the light emitting device, a second current source coupled to an output terminal of the light emitting device, and a logic module for controlling the first current source and the second current source according to voltages of the input terminal and the output terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a process for driving a light emitting device in accordance with the present invention.

FIG. 2 illustrates a schematic diagram of a driving circuit in accordance with the present invention.

FIG. 3 illustrates a schematic diagram of a logic module in accordance with an embodiment of the present invention.

### DETAILED DESCRIPTION

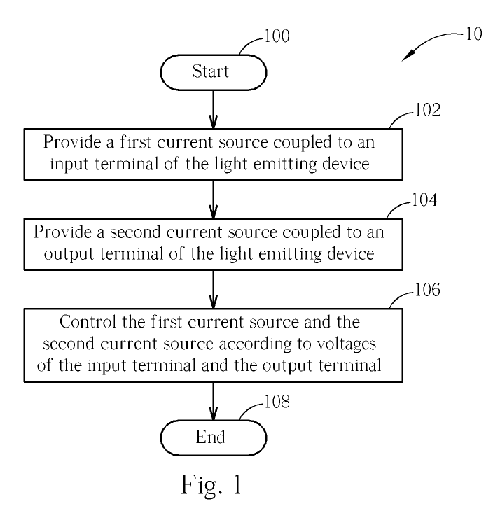

Please refer to FIG. 1, which illustrates a flowchart of a process 10 for driving a light emitting device in accordance with the present invention. The process 10 comprises the following steps:

Step 100: start.

Step 102: provide a first current source coupled to an input terminal of the light emitting device.

Step 104: provide a second current source coupled to an output terminal of the light emitting device.

Step 106: control the first current source and the second current source according to voltages of the input terminal and the output terminal.

Step 108: end.

According to the process 10, the present invention drives the light emitting device with two current sources coupled to the input and output terminals of the light emitting device, and controls the current sources according to the voltages of the input and output terminals. Therefore, no matter which terminal experiences a circuit short with a voltage source or ground, the present invention can protect the light emitting device from receiving too much current by importing stable current into the input terminal and drawing the same amount of current from the output terminal. That is, even if one of the terminals is shorted with the voltage source or the ground, the present invention still drives the light emitting device with the stable current, and thus, conforms to the eye safety requirements, which must be observed not only during normal operation but when single faults occur. For example, if the input terminal of the light emitting device is shorted with the voltage source, current flowing into the input terminal is over an acceptable current of the light emitting device. Since the current source coupled to the output terminal is not shorted with the ground, the extra current within the light emitting device has no way to be drained out. Thus, the light emitting device can work regularly with the stable current drawn by the current source coupled to the output terminal. Similarly, if the output terminal of the light emitting device is shorted with the ground, current flowing out from the output terminal is over the acceptable current of the light emitting device. Since the current source coupled to the input terminal is not shorted with the voltage source, the light emitting device has no way to absorb extra current. Thus, the light emitting device can work regularly with the stable current provided by the current source coupled to the input terminal.

In addition, the present invention can switch the current sources according to an operation status of the light emitting device. For example, if the light emitting device is operated in a sleep mode, the present invention can turn off the current sources for saving energy.

Therefore, in order to prevent the light emitting device from flashing or being damaged, the present invention drives the light emitting device with two current sources coupled to the input and output terminals of the light emitting device, and controls the current sources according to the voltages of the input and output terminals.

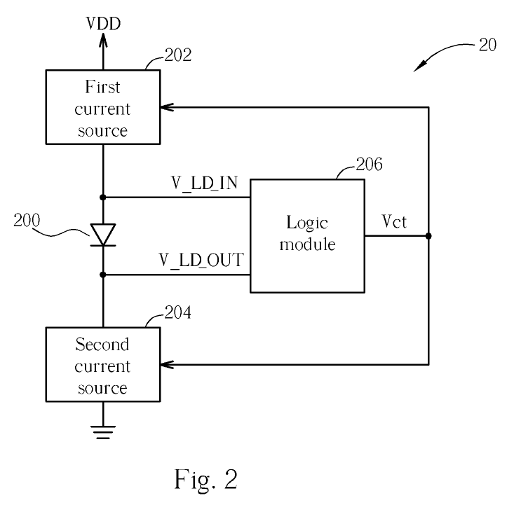

Please refer to FIG. 2, which illustrates a schematic diagram of a driving circuit 20 in accordance with the present invention. The driving circuit 20 is utilized for implementing the process 10. The driving circuit 20 can drive a light emitting device 200, such as an LED and an LD, and comprises a first current source 202, a second current source 204, and a logic module 206. The first current source 202 is coupled to an input terminal of the light emitting device 200. The second current source 204 is coupled to an output terminal of the light emitting device 200. According to voltages V_LD_IN and V_LD_OUT of the input terminal and the output terminal of the light emitting device 200, the logic module 206 controls the first current source 202 and the second current source 204 with a control signal Vct.

The driving circuit 20 drives the light emitting device 200 with the first and second current sources 202 and 204, and controls the first and second current sources 202 and 204 according to the voltages V_LD_IN and V_LD_OUT. Therefore, no matter which terminal of the light emitting device 200 is shorted with a voltage source VDD or ground, the driving circuit 20 can protect the light emitting device 200 from receiving too much current. That is, even if one of the terminals is shorted with the voltage source VDD or the ground, the driving circuit 20 still drives the light emitting device 200 with the stable current, and thus, conforms to the eye safety requirements, which must be observed not only during normal operation but when single faults occur. For example, if the input terminal of the light emitting device 200 is shorted with the voltage source VDD, current flowing into the input terminal is over an acceptable current of the light emitting device 200. Since the second current source 204 is not shorted with the ground, the extra current within the light emitting device 200 has no way to be drained out. Thus, the light emitting device 200 can work regularly with the stable current drawn by the second current source 204. Similarly, if the output terminal of the light emitting device 200 is shorted with the ground, current flowing out from the output terminal is over the acceptable current of the light emitting device 200. Since the first current source 202 is not shorted with the voltage source VDD, the light emitting device 200 has no way to absorb extra current. Thus, the light emitting device 200 can work regularly with the stable current provided by the first current source 202.

In addition, the logic module 206 can switch the first and second current sources 202 and 204 according to an operation status of the light emitting device 200. For example, if the light emitting device 200 is operated in a sleep mode, the logic module 206 can turn off the first and second current sources 202 and 204 for saving energy.

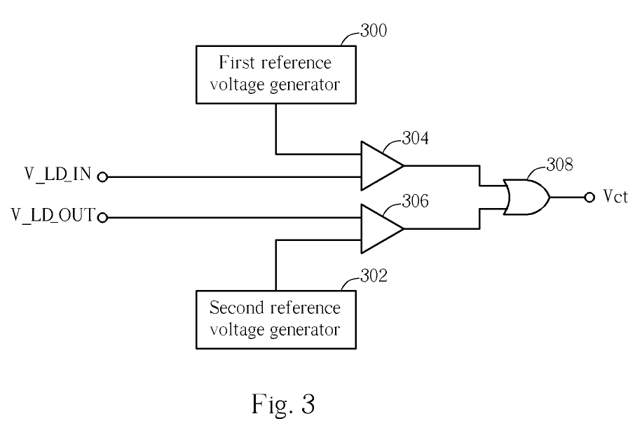

Please refer to FIG. 3, which illustrates a schematic diagram of a logic module 30 in accordance with an embodiment of the present invention. The logic module 30 is utilized for implementing the logic module 20 shown in FIG. 2, and comprises a first reference voltage generator 300, a second reference voltage generator 302, a first comparison unit 304, a second comparison unit 306, and a logic gate 308. The first and second comparison units 304 and 306 compare the voltages V_LD_IN and V_LD_OUT with reference voltages generated by the first and second reference voltage generators 300 and 302. Then, according to results of the first and second comparison units 304 and 306, the logic gate 308 outputs the control signal Vct to the first and second current sources 202 and 204, which are turned on when the control signal Vct is high, and turned off when the control signal Vct is low. The logic gate 308 is preferably an OR gate, meaning that as long as one of the results of the first and second comparison units 304 and 306 is high, the control signal Vct is high. Therefore, other than a situation in which both of the results of the first and second comparison units 304 and 306 are low, the control signal Vct is high, and the light emitting device 200 can work under the eye safety requirements.

Using the logic module 30 shown in FIG. 3, the driving circuit 20 can prevent overdriving the light emitting device 200 when one of the voltages V_LD_IN and V_LD_OUT exceed the reference voltages generated by the first and second reference voltage generators 300 and 302. Therefore, the driving circuit 20 can prevent the light emitting device 200 from flashing or being damaged.

In summary, the present invention drives the light emitting device with two current sources coupled to the input and output terminals of the light emitting device, and controls the current sources according to the voltages of the input and output terminals, so as to prevent the light emitting device from flashing or being damaged. The light emitting device can be a light emitting diode, a laser diode, etc. The current sources, the comparison units, the reference voltage generators, and the logic gate can be any kind of circuits implementing corresponding functions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a light emitting device, comprising:
providing a first current source coupled to an input terminal of the light emitting device; and
providing a second current source coupled to an output terminal of the light emitting device.

2. The method of claim 1, further comprising controlling the first current source and the second current source according to voltages of the input terminal and the output terminal.

3. The method of claim 1, further comprising controlling the first current source and the second current source according to an operation status of the light emitting device.

4. The method of claim 3, wherein controlling the first current source and the second current source according to the operation status of the light emitting device comprises turning both the first current source and the second current source off when the light emitting device is operated in a sleep mode.

5. The method of claim 1, wherein the light emitting device is a light emitting diode.

6. The method of claim 1, wherein the light emitting device is a laser diode.

7. An apparatus for driving a light emitting device, comprising:
a first current source coupled to an input terminal of the light emitting device; and
a second current source coupled to an output terminal of the light emitting device.

8. The apparatus of claim 7, further comprising a logic module for controlling the first current source and the second current source according to voltages of the input terminal and the output terminal.

9. The apparatus of claim 7, wherein the logic module is further utilized for controlling the first current source and the second current source according to an operation status of the light emitting device.

10. The apparatus of claim 9, wherein the logic module is utilized for turning both the first current source and the second current source off when the light emitting device is operated in a sleep mode.

11. The apparatus of claim 8, wherein the logic module comprises:
a first reference voltage generator for generating a first reference voltage;
a second reference voltage generator for generating a second reference voltage;
a first comparison unit coupled to the first reference voltage generator and the input terminal of the light emitting device, for comparing voltage of the input terminal with the first reference voltage;
a second comparison unit coupled to the second reference voltage generator and the output terminal of the light emitting device, for comparing voltage of the output terminal with the second reference voltage; and
a logic gate coupled to the first comparison unit, the second comparison unit, the first current source and the second current source, for controlling the first current source and the second current source according to results of the first comparison unit and the second comparison unit.

12. The apparatus of claim 11, wherein the logic gate is an OR gate.

13. The apparatus of claim 8, wherein the light emitting device is a light emitting diode.

14. The apparatus of claim 8, wherein the light emitting device is a laser diode.
